(19) United States
(12) Patent Application Publication
(10) Pub. No.: US 2011/0123718 A1
(43) Pub. Date: May 26, 2011

(54) Handheld roller device for painting corners

(76) Inventors: Bruce D. Weis, Joliet, IL (US); Bradley D. Weis, Minooka, IL (US)

(21) Appl. No.: 12/592,172

(22) Filed: Nov. 20, 2009

(51) Int. Cl. B05D 1/28; B05C 17/02

(52) U.S. Cl. 427/428.01; 118/258

(57) ABSTRACT

A handheld roller device for painting corners 10 includes a handle member 12, a roller assembly 14 secured to the handle member 12 by an angle bar 16, a first ball transfer retainer 18 forcibly and removably inserted into a recess 20 in an outer end 22 of a rotating roller member 24, at least one first ball transfer member 26 secured to the first ball transfer retainer 18, and at least one second ball transfer member 34 secured to an end portion 36 of the angle bar 16, such that the first and second ball transfer members 26 and 34 engage a first wall 30 while the roller member 24 applies paint to a second wall 32.

### BACKGROUND OF THE INVENTION

1. Field of the Invention

This invention relates to roller brushes, and more particularly, to a handheld roller device for painting perpendicularly joined walls different colors without contaminating the paint of either wall with paint from the adjacent wall.

2. Background Of The Prior Art

Hand held roller devices for painting relatively large, planar surface areas are well known. Roller devices can apply paint to walls and ceilings relatively close to corners, but cannot completely cover a first wall that forms a corner without engaging and applying paint to the second wall forming the corner. Thus, the roller device is manually urged upon the first wall relatively close to the second wall, resulting in a relatively “thin” strip of unpainted first wall that forms the corner.

To complete the painting of the thin strip and corner, a corner device must be utilized that slides upon the first wall sufficiently close to the second wall to apply paint only to the first wall, while avoiding engagement with the second wall, resulting in the painting of the thin strip and the first wall without applying paint to the second wall.

The problem is that switching back and forth between the roller device and the corner device to paint a relatively large wall surface and a corner is time consuming, and wastes paint and money. A need exists for a roller device that paints a relatively large surface area on a first wall, and that engages a second wall portion that forms a corner with a first wall portion, such that paint is applied from the roller device to the first wall sufficiently close to the second wall portion to completely cover the first wall portion forming the corner without applying paint to the adjacent second wall portion forming the corner.

### SUMMARY OF THE INVENTION

It is an object of the present invention to overcome many of the disadvantages associated with prior art devices for painting perpendicularly joined walls different colors without contaminating the paint of either wall with paint from the adjacent wall.

A principal object of the present invention is to provide a device that engages a first wall while applying paint to a second wall perpendicularly joined to the first wall. A feature of the device is a roller assembly for applying paint to the second wall. Another feature of the device is a handle member secured to the roller assembly, the roller assembly being secured to the handle member by an angle bar. Yet another feature of the device is a first ball transfer member for rotationally engaging the first wall, the first ball transfer member being secured to a wall engagement end of the roller assembly. An advantage of the device is that a user can manually apply paint to the second wall while the first ball transfer member engages the first wall such that the paint being applied to the second wall is not applied to the first wall.

Another object of the present invention is to provide a device with two separated portions that engage a first wall, the two separated portions cooperating to guide the roller assembly upon the first wall such that only a second wall that is perpendicular to the first wall receives paint thereupon. A feature of the device is a second ball transfer member secured to an end portion of the angle bar, the angle bar being orientated to dispose the second ball transfer member upon the first wall. An advantage of the device is that the first and second ball transfer members cooperatively engage the first wall to guide the roller assembly such that only a second wall that is perpendicular to the first wall receives paint thereupon, thereby allowing a second color paint to be applied to the adjacent second wall while maintaining the integrity of a first color paint on the first wall when the user operates the handheld roller device.

Yet another object of the present invention is to provide a device that urges the roller assembly toward the first wall while a user applies paint to a second wall. A feature of the device is a spring member disposed between a spring retainer and an inner end portion of the roller assembly to urge the roller assembly and the first ball transfer member upon the first wall while paint is applied adjacent to the first wall and upon the second wall. An advantage of the device is that the spring member is dimensioned and configured to provide sufficient force to urge the roller assembly toward the second wall such that the first ball transfer member maintains engagement with the second wall, irrespective of the user inconsistently positioning the handheld roller device relative to the second wall, thereby maintaining a constant distance between the first wall and an edge portion of the paint applied to the second wall via the handheld roller device.

Another object of the present invention is to provide a device with a handle member that is adjustably secured to the angle bar. A feature of the device is a handle adjustment member that snugly slides upon the angle bar. An advantage of the device is that the handle member is adjustably secured circumferentially about and longitudinally upon the angle bar to assist the user when orientating the handheld roller device relative to the second wall.

Another object of the present invention is to provide a device that prevents the roller member from falling from the roller assembly. A feature of the device is a circumferentially channeled inner end portion for receiving a retaining clamp therein. An advantage of the device is that the roller member is maintained upon the roller assembly irrespective of the orientation of the device.

Another object of the present invention is to provide a device that maintains the position of the first ball transfer member in an end portion of the roller member. A feature of the device is an inner clamp portion for securing a first ball transfer retainer to a cooperating retaining bar portion of in roller assembly. An advantage of the device is that the first ball transfer retainer is prevented from escaping a recess in a wall engagement end of said the roller member irrespective of the orientation of the device.

Briefly, the invention provides a handheld roller device for painting corners comprising: a handle member; a roller assembly secured to said handle member by an angle bar; a first ball transfer member secured to a wall engagement end of said roller assembly such that said first ball transfer member engages a first wall; and a second ball transfer member secured to an end portion of an extension rod, said extension rod being orientated to dispose said second ball transfer member such that said second ball transfer member engages the first wall, whereby said first and second ball transfer members cooperate to guide said roller assembly upon the first wall such that only a second wall that is perpendicular to the first wall receives a second color paint thereupon, thereby allowing a second color paint to be applied to the second wall while maintaining the integrity of the first color paint on the first wall when the user operates said handheld roller device.

Further, the invention provides a method for painting perpendicularly joined walls different colors without contaminating the paint of either wall with paint from the adjacent wall, said method comprising the steps of: providing a roller assembly with a handle attached thereto; securing a first ball transfer assembly to an outer end portion of said roller member such that said first ball transfer assembly engages a first wall, whereby said first ball transfer assembly guides said roller member upon the first wall such that a second wall receives a second color paint thereupon, while the adjacent first wall that is perpendicular to the second wall is not defaced with the second color paint, thereby maintaining the integrity of the first color paint upon the first wall; and securing a second ball transfer assembly to an end portion of an extension rod such that said second ball transfer assembly engages the first wall, whereby said first and second ball transfer assemblies cooperate to guide said roller member upon the first wall such that the second wall receives the second color paint thereupon, while the adjacent first wall does not receive the second color paint thereupon.

Also, the invention provides a device for painting a ceiling a first color and a wall a second color without commingling the first and second colors comprising: a roller member having a first ball transfer member removably secured to a wall engagement end of said roller member; a handle member secured to said roller member such that said roller member rotates while said handle member is manually supported; and a second ball transfer member secured to an end portion of an extension rod, said extension rod being orientated to dispose said second ball transfer member such that said second ball transfer member engages the wall, whereby said first and second ball transfer members cooperatively engage a wall surface while said roller member engages a ceiling surface adjacent and perpendicularly disposed relative to the wall surface, said first and second ball transfer members guiding said roller member while a user manually urges a first color paint from said roller member upon the ceiling surface such that the first color paint is disposed adjacent to the second color paint upon the wall surface without engaging the second color paint upon the wall surface.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a perspective view of a handheld roller device for painting corners in accordance with the present invention.

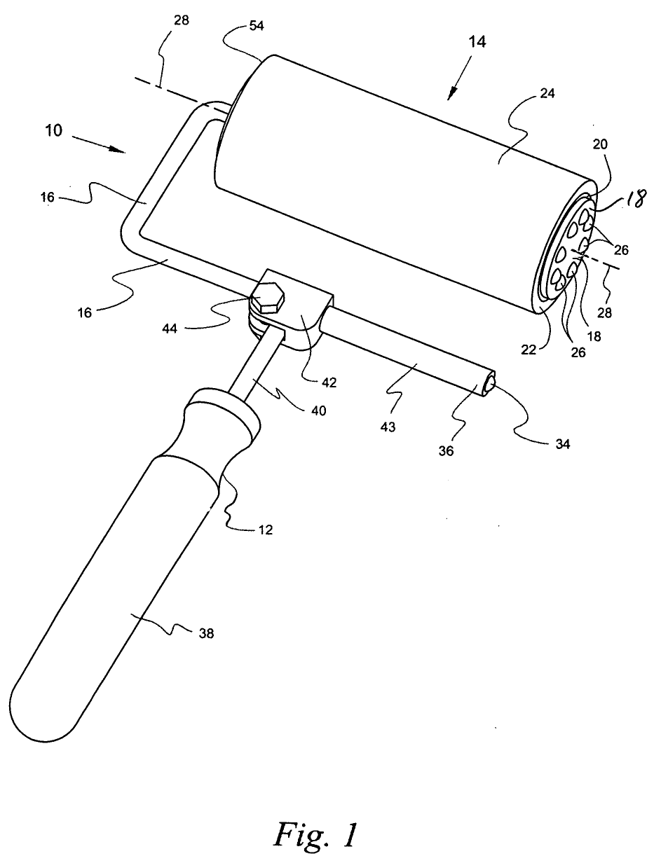

FIG. 2 is an exploded view of FIG. 1.

FIG. 3 is the perspective view of FIG. 1, but with an outer bias member 58 added and the roller member 24 removed.

FIG. 4 is a perspective view of a second ball transfer retainer 37 with multiple second ball transfer members 34 secured therein.

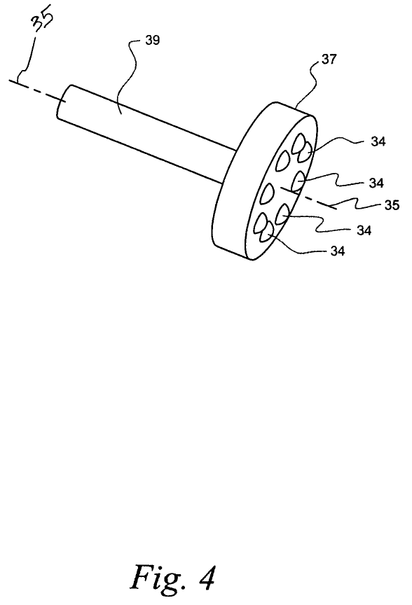

FIG. 5 is a perspective view of a first ball transfer retainer 18.

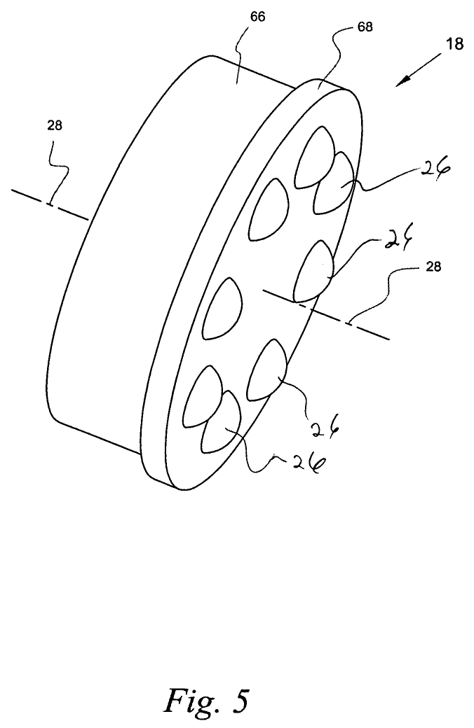

FIG. 6 is a perspective view of a modified first ball transfer retainer 80 of the retainer 18 depicted FIG. 5, the modified retainer 80 depicting an inner clamp portion 78 in accordance with the present invention.

FIG. 7 is a perspective view of a roller member with a retaining bar 76 for detachably receiving the inner clamp portion 78 of FIG. 6.

FIG. 8 is a top elevation view of a handheld roller device painting a second wall 32, while first and second ball transfer members 26 and 34 engage a first wall 30 that forms a corner with the second wall 32 in accordance with the present invention.

FIG. 9 is a perspective view of a handheld roller device for painting corners, but with a retaining clamp 74 added for maintaining a roller member 24 (not depicted) upon an inner bias member 52 in accordance with the present invention.

FIG. 10 is a perspective view of a roller member 24 with a circumferential channel 70 for receiving a tip portion 73 of the retaining clamp 74 of FIG. 9 in accordance with the present invention.

### DESCRIPTION OF THE PREFERRED EMBODIMENT

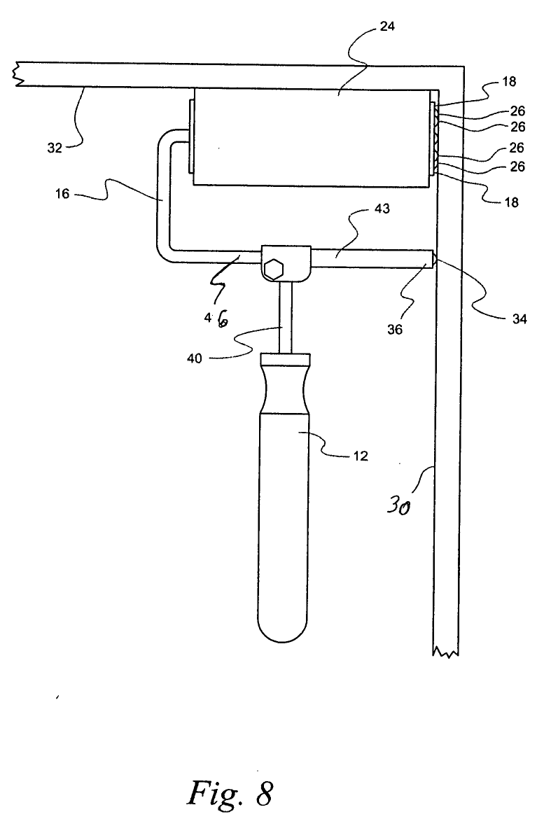

Referring now to figures, a handheld roller device for painting corners in accordance with the present invention is denoted as numeral 10. The device 10 includes a handle member 12, a roller assembly 14 secured to the handle member 12 by an angle bar 16, a first ball transfer retainer 18 forcibly and removably inserted into a recess 20 in a wall engagement end 22 of a rotating roller member 24 which is part of the roller assembly 14, and a plurality of first ball transfer members 26 secured in the first ball transfer retainer 18. The first ball transfer members 26 are symmetrically disposed about a central axis 28 of the first ball transfer retainer 18 such that the first ball transfer members 26 ultimately engage a first wall 30 (see FIG. 8), thereby preventing the first ball transfer retainer 18 from engaging the first wall 30 while the first ball transfer members 26 rotate upon the first wall 30. The rotational operation of the first ball transfer members 26 upon the first wall 30 cooperate with the handle member 12 and angle bar 16 to guide the wall engagement end 22 of the roller member 24 parallel, adjacent and unobstructed relative to the first wall 30, while the roller member 24 is manually urged to apply a second color paint upon a second wall 32 (see FIG. 8) such that the second color paint does not engage a first color paint on the first wall 30.

To increase the stability of the device 10 when manually urged to paint perpendicular corners, the device 10 further includes a rotational second ball transfer member 34 secured in an end portion 36 of an extension rod 43 that is integrally joined to a channel member 42 that is forcibly secured upon a bend portion 48 of the angle bar 16. The bend portion 48 inserts into a channel 47 in the channel member 42, whereupon, a bolt 44 inserts through an aperture 49 in the channel member 42 and a nut 45 is rotationally secured upon the bolt 44 to “pinch” opposing channel walls 51 together, thereby securing the channel member 42 upon the bend portion 48 such that the second ball transfer member 34 is positioned to engage the first wall 30 simultaneously with the first ball transfer member 26 when the roller member 24 engages the second wall 32.

Although the extension rod 43 is depicted as being detachable which allows the rod 43 to be used with a new device 10 or for retrofitting prior art roller devices, a myriad of attachment techniques may be used, including but no limited to welding, soldering, adhesives and coupling mechanisms all well known to those of ordinary skill in the art. The preferred attachment technique is to use coupling mechanisms that allow the extension rod 43 to be slightly adjustable upon a longitudinal portion 46 of the angle bar 16, such that the longitudinal axes of the extension rod 43 and longitudinal portion 46 remain aligned as the rod 43 disposes the second ball transfer member 34 closer to or farther from the first wall 30 as required orientate the device 10 as depicted in FIG. 8. The channel member 42 and extension rod 43 are manufactured from stainless steel. The extension rod 43 can be tubular or a solid bar with a drilled end portion 36. Irrespective of the extension rod 43 being tubular or solid, the inner diameter of the end portion 36 is dimensioned to snugly receive the second ball transfer member 34.

The angle bar 16 is configured and dimensioned to cooperate with the channel member 42 and extension rod 43 to dispose the second ball transfer member 34 such that the second ball transfer member 34 engages the first wall 30 together with the first ball transfer members 26 when a longitudinally axis of the roller member 24 is orientated perpendicularly to the first wall 30. Ultimately, the first and second ball transfer members 26 and 34, and the handle 12 and angle bar 16, cooperate to guide the wall engagement end 22 of the roller member 24 parallel, adjacent and unobstructed relative to the first wall 30, while the roller member 24 is manually urged to apply a second color paint upon the second wall 32 such that the second color paint does not engage a first color paint on the first wall 30.

The handle member 12 includes a plastic hand grip portion 38 that receives an anchor portion 40 of the angle bar 16. The channel member 42 ultimately engages the anchor portion 40 and the bend portion 48 such that the channel member 42 can be slidably positioned upon the angle bar 16 to ultimately dispose the second ball transfer member 34 upon the first wall 30 in aligned cooperation with the first ball transfer member 26 as illustrated in FIG. 8. The channel member 42 is forcibly compressed about the angle bar 16 by the bolt 44 and nut 45, thereby tightly and adjustably joining the rod portion 40 to the angle bar 16 to allow the handle member 12 to be manually disposed at a position that minimizes the manual force required to rotate a paint “soaked” roller member 24 upon portions of a ceiling or wall that form a corner.

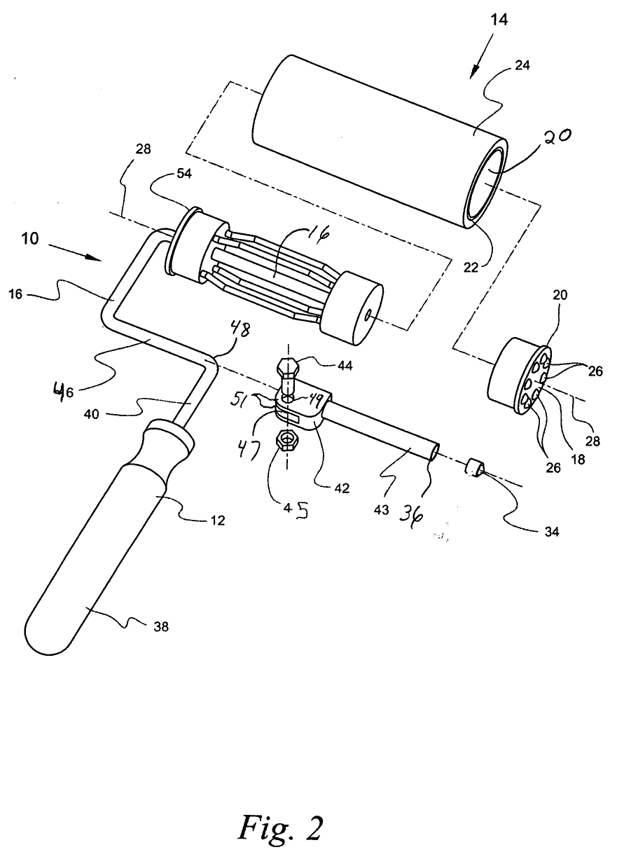

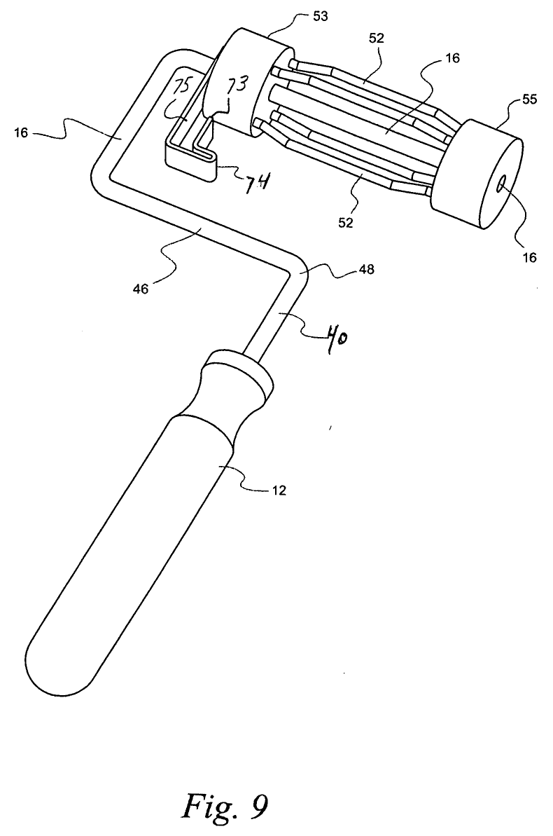

The angle bar 16 may be fabricated from myriad of materials but stainless steel is preferred. The angle bar 16 is comparable in configuration and dimension to a standard angle bar 46 as illustrated in FIGS. 2 and 9, however, the standard angle bar 46 can be configured to any form that cooperates with the longitudinal dimension of the extension rod 43 to ultimately dispose the second ball transfer member 34 upon the first wall 30 in cooperative alignment with the first ball transfer member 26. The angle bar 16 of the present invention must be longitudinally dimensioned to dispose the second ball transfer member 34 relative to the first ball transfer members 26 such that the roller member 24 and the handle portion 43 are disposed perpendicular to the first wall 30 and parallel to the second wall 32, while the first and second ball transfer members 26 and 34 engage the first wall 30 (see FIG. 8).

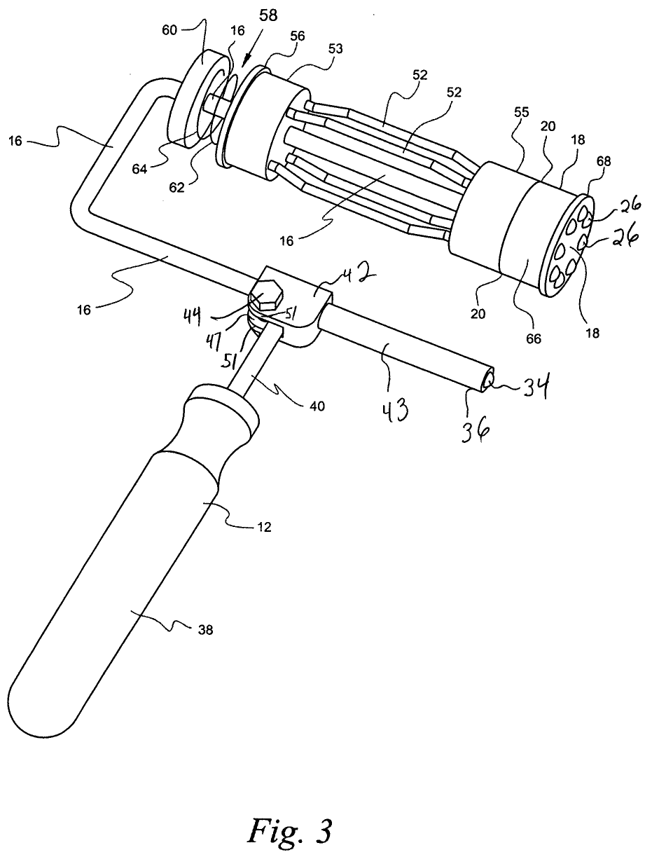

The roller assembly 14 may include an inner bias member 52 (see FIG. 3) that is well known to those of ordinary skill in the art and is used to retain the roller member 24 upon cooperating inner and outer shoulder portions 53 and 55 such that an inner end 54 of the roller member 24 maintains engagement against a hub member 56 of the roller assembly 14. However, unlike the prior art, the present invention may include an outer bias member 58 that forcibly maintains the first ball transfer members 26 upon a first wall 30, irrespective of a relatively small variation in position of a users hand relative to the first wall 30. The bias member 58 includes a stainless steel spring retainer 60 and a stainless steel spring member 62. The spring retainer 60 is secured to the angle bar 16 via means well known to those of ordinary skill in the art, and the spring member 62 is removably disposed upon the angle bar 16 such that an inner end 64 engages the spring retainer 60, and an outer end (not depicted) of the spring member 62 ultimately engages the hub member 56 of the roller assembly 14.

The spring member 62 is dimensioned and configured to provide sufficient force to urge the roller assembly 14 toward the second wall such that the first ball transfer member 26 or multiple first ball transfer members 26 maintain engagement with the second wall 32, irrespective of the user inconsistently positioning the handheld roller device 10 relative to the second wall 32, thereby providing paint upon the first wall 30 that is sufficiently close to the second wall 32 such that a painted corner is seen with a first color paint only on the first wall 30 and a second color paint only on the second wall 32 with no “unpainted” space between the first and second walls 30 and 32. The amount of movement of the handle member 12 away from the second wall 32 that the bias member 52 can accommodate and still maintain engagement of the first ball transfer members 26 and the second wall 32 corresponds to the axial compression of the spring member 62. For example, if the spring member 62 is compressed one inch with the handle member 12 being three inches from the second wall 32, then the maximum distance that the user can move the handle member 12 away from the second wall 32 and still maintain contact between the first ball transfer members 26 and the second wall 32 is four inches.

The roller member 24 is typical to a prior art roller that is disposed upon the first bias member 52, except for the recess 20 in the wall engagement end 24. The recess 20 is dimensioned to snugly receive the first ball transfer retainer 18 such that the retainer 18 is centrally disposed in the recess 20 with the roller member 24 providing sufficient holding force to prevent the retainer 18 from falling from the recess 20 irrespective of the position of the roller member 24. The retainer 18 is a relatively light weight portion of plastic having a cylindrically configured inner portion 66 that inserts into the recess 20, and a relatively “thin” cylindrically configured outer portion 68 that engages the wall engagement end 22 of the roller member 24 and snugly receives one axially disposed first ball transfer member 26 or a plurality of first ball transfer members 26 symmetrically and circumferentially disposed about the central axis 28 of the first ball transfer retainer 18.

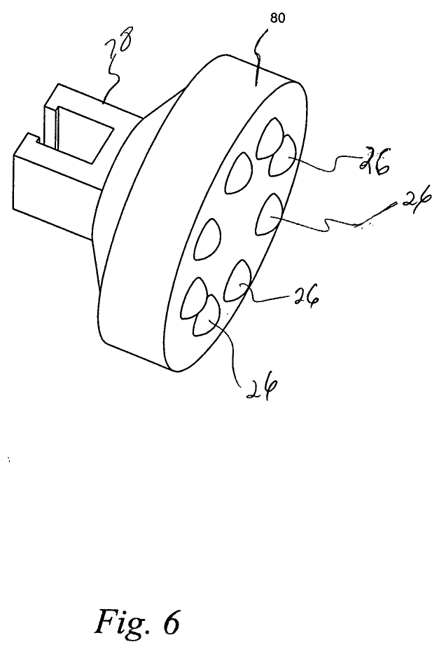

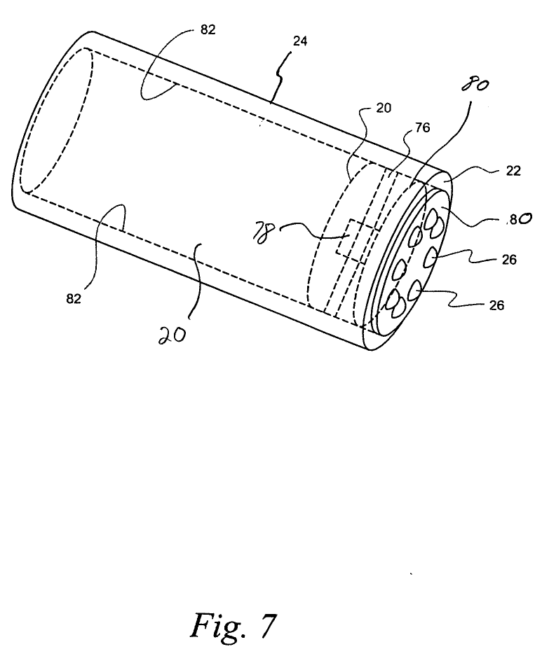

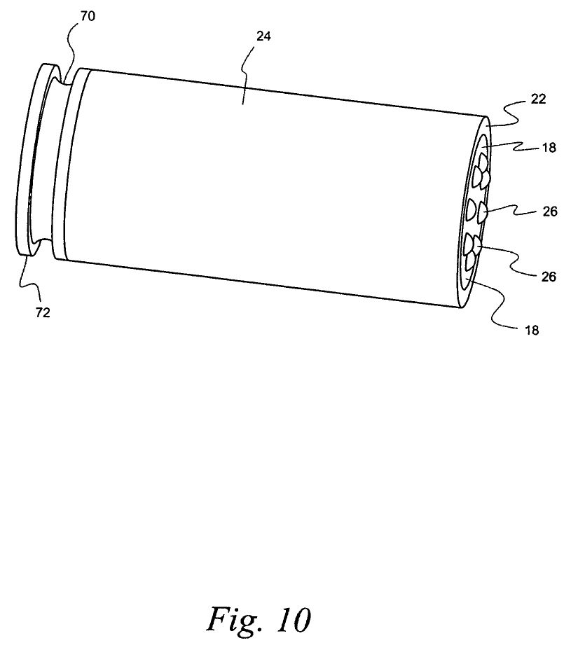

The roller member 24 may include a circumferential channel 70 (see FIG. 10) disposed about an inner end 72 portion for receiving a tip portion 73 of a retaining clamp 74 (see FIG. 9) therein to prevent the roller member 24 from sliding off the inner bias member 52. The retaining clamp 74 is manually “flexed” and held away from the channel 70 to allow the roller member 24 to be slid upon the inner bias member 52 until the inner end 72 of the roller member 24 engages an inner portion 75 of the retaining clamp 74, whereupon, the retaining clamp 74 is released and the tip portion 73 allowed to engage the channel 70 to maintain the position of the roller member 24 upon the inner bias member 52. Further, the roller member 24 may include a radially disposed retaining bar 76 (see FIG. 7) integrally joined to a cylindrical inner wall 82 of the roller member 24 to detachably receive a cooperating inner clamp portion 78 of a modified first ball transfer retainer 80 (see FIG. 6), thereby preventing the retainer 80 from escaping the recess 20 in the wall engagement end 22 of the roller member 24. The retaining bar 76 and the inner clamp portion 78 are both fabricated from flexible plastic that is configured to allow the clamp portion 78 to be manually urged upon the bar 76, and to allow the clamp portion 78 to be manually separated from the retaining bar 76 when the modified first ball transfer retainer 80 is forcibly removed from the roller member 24 for cleaning.

The first and second ball transfer members 26 and 34 are manufactured by a myriad of companies including Hudson Bearings, Inc, located at 13 Colton Road, East Lyme, Conn. 06333. When using single first and second ball transfer members 26 and 34, the preferred part number is NMBT. When using a plurality of first and/or second ball transfer members 26 and 34, correspondingly smaller members 26 and 34 are used, that are manufactured by competing suppliers. The members 26 and 34 are readily disposed in the first ball transfer retainer 18 and the end portion 36 of the angle bar 16 by drilling recesses (not depicted) in the first ball transfer member 18 and the end portion 36 of the extension rod 43 if the rod is solid bar stock. Obviously, if the extension rod 43 is tubular, the rod 43 need not be drilled. The drilled recesses are dimensioned and configured to snugly receive respective first and second ball transfer members 26 and 34 such that the members do not escape the recesses irrespective of the orientation of the handheld roller device 10.

In operation, a handheld roller device 10 is dimensioned to accommodate a user's ability to paint corners formed by perpendicularly joined first and second walls 30 and 32. A relatively small device 10 will include a single first ball transfer member 26 disposed in a first ball transfer retainer 18, and a second ball transfer member 34 disposed in a recess in an end portion 36 of an angle bar 16. If a relatively large device 10 is used to paint the first and second walls 30 and 32, then a plurality of first ball transfer members 26 will be circumferentially disposed about a central axis 28 of the first ball transfer retainer 18, and a plurality of second ball transfer members 34 will be circumferentially disposed about a central axis 35 of a second ball transfer retainer 37. The retainer 37 will be secured to the extension rod 43 via a rod portion 39 of the retainer 37 being snugly inserted into the recess in the end portion 36 of the extension rod 43.

After selecting the optimum first and second ball transfer members 26 and 34, the user positions the handle member 12 for optimum leverage by sliding and securing the channel member 42 upon a longitudinal portion 46 of the angle bar 16. The user then dips the roller member 24 in a second color paint then disposed the roller member 24 against a second wall 32 such that the first and second ball transfer members 26 and 34 engage the first wall 30. The user then rotates the roller member 24 upon the second wall 32 while maintaining engagement between the first and second ball transfer members 26 and 34 and the first wall 30, until a predetermined portion of the second wall 32 forming a corner with the first wall 30 is coated with the second color paint.

After the second color paint has dried upon the second wall 32, and the device 10 has been cleaned of the second color paint, the roller member 24 is then coated with a first color paint. The roller member 24 is then disposed against the first wall 30 such that the first and second ball transfer member 26 and 34 engage the second wall 32. The user then rotates the roller member 24 upon the first wall 30 while maintaining engagement between the first and second ball transfer members 26 and 34 and the second wall 32, until a predetermined portion of the first wall 30 forming the corner with the second wall 32 is coated with the first color paint, thereby completing the painting of the corner formed by the perpendicularly joined first and second walls 30 and 32.

The foregoing description is for purposes of illustration only and is not intended to limit the scope of protection accorded this invention. The scope of protection is to be measured by the following claims, which should be interpreted a broadly as the inventive contribution permits.

1. A handheld roller device for painting corners comprising:
a handle member;
a roller assembly secured to said handle member by an angle bar;
a first ball transfer member secured to a wall engagement end of said roller assembly such that said first ball transfer member engages a first wall; and
a second ball transfer member secured to an end portion of an extension rod, said extension rod being orientated to dispose said second ball transfer member such that said second ball transfer member engages the first wall, whereby said first and second ball transfer members cooperate to guide said roller assembly upon the first wall such that only a second wall that is perpendicular to the first wall receives a second color paint thereupon, thereby allowing a second color paint to be applied to the second wall while maintaining the integrity of the first color paint on the first wall when the user operates said handheld roller device.

2. The device of claim 1 wherein said roller assembly includes a roller retention portion and a bias portion.

3. The device of claim 2 wherein said bias portion includes a spring retainer and a spring member disposed between said spring retainer and an inner end portion of said roller assembly.

4. The device of claim 3 wherein said spring member is dimensioned and configured to provide sufficient force to urge said roller assembly toward the second wall such that said first ball transfer member maintains engagement with the second wall, irrespective of the user inconsistently positioning said handheld roller device relative to the second wall.

5. The device of claim 1 wherein said roller assembly includes a roller member having a recess in an outer end, said recess ultimately receiving a first ball transfer retainer with said first ball transfer member centrally disposed in said first ball transfer retainer.

6. The device of claim 1 wherein said angle bar includes a channel member for adjustably securing said extension rod in axial alignment with a longitudinal portion of said angle bar to assist the user when orientating said handheld roller device relative to the first wall.

7. The device of claim 5 wherein said first ball transfer retainer includes a plurality of first ball transfer members symmetrically disposed about a central axis of said first ball transfer retainer.

8. The device of claim 1 wherein said end portion of said extension rod includes a recess for receiving a shaft portion of a second ball transfer retainer, said second ball transfer retainer having a plurality of second ball transfer members symmetrically disposed about a central axis of said second ball transfer retainer.

9. The device of claim 5 wherein said roller member includes a circumferentially channeled inner end portion for receiving a retaining clamp therein to prevent said roller member from sliding off an inner bias member.

10. The device of claim 5 wherein said first ball transfer retainer includes an inner clamp portion for securing said first ball transfer retainer to a cooperating retaining bar portion of said roller assembly, thereby preventing said first ball transfer retainer from escaping said recess in said wall engagement end of said roller member.

11. A method for painting perpendicularly joined walls different colors without contaminating the paint of either wall with paint from the adjacent wall, said method comprising the steps of:
providing a roller assembly with a handle attached thereto;
securing a first ball transfer assembly to an outer end portion of said roller member such that said first ball transfer assembly engages a first wall, whereby said first ball transfer assembly guides said roller member upon the first wall such that a second wall receives a second color paint thereupon, while the adjacent first wall that is perpendicular to the second wall is not defaced with the second color paint, thereby maintaining the integrity of the first color paint upon the first wall; and
securing a second ball transfer assembly to an end portion of an extension rod such that said second ball transfer assembly engages the first wall, whereby said first and second ball transfer assemblies cooperate to guide said roller member upon the first wall such that the second wall receives the second color paint thereupon, while the adjacent first wall does not receive the second color paint thereupon.

12. The method of claim 11 wherein said step of providing a roller assembly includes the step of providing a roller retention portion and a bias portion.

13. The method of claim 12 wherein the step of providing a bias portion includes the step of providing a means for urging said first ball transfer assembly into engagement with the first wall such that the first wall does not receive the second color paint of the second wall.

14. The method of claim 13 wherein said urging means includes a spring that maintains said first ball transfer assembly against the first wall irrespective of the user not manually following a paint path parallel to the first wall, thereby painting the second wall with a second color paint sufficiently close to the first wall.

15. The method of claim 11 wherein said step of disposing a roller member upon said roller assembly includes the step of providing a recess in an outer end portion of said roller member for receiving said first ball transfer assembly.

16. The method of claim 11 wherein said step of providing a first ball transfer assembly includes the step of disposing a plurality of first ball transfer members symmetrically about a central axis of said roller member.

17. The method of claim 11 wherein said step of providing a second ball transfer assembly includes the step of disposing a plurality of second ball transfer members symmetrically about a central axis of said second ball transfer assembly.

18. The method of claim 11 wherein said step of securing said second ball transfer assembly to said end portion of said extension rod includes the step of providing a channel member for securing said extension rod to a bend portion of an angle bar.

19. The device of claim 11 wherein said step of securing said first ball transfer assembly includes the step of providing an inner clamp portion for said first ball transfer assembly to secure a first ball transfer retainer to a cooperating retaining bar portion of a roller member, thereby preventing said first ball transfer retainer from escaping a recess in a wall engagement end of said roller member.

20. A device for painting a ceiling a first color and a wall a second color without commingling the first and second colors comprising:
a roller member having a first ball transfer member removably secured to a wall engagement end of said roller member;
a handle member secured to said roller member such that said roller member rotates while said handle member is manually supported; and
a second ball transfer member secured to an end portion of an extension rod, said extension rod being orientated to dispose said second ball transfer member such that said second ball transfer member engages the wall, whereby said first and second ball transfer members cooperatively engage a wall surface while said roller member engages a ceiling surface adjacent and perpendicularly disposed relative to the wall surface, said first and second ball transfer members guiding said roller member while a user manually urges a first color paint from said roller member upon the ceiling surface such that the first color paint is disposed adjacent to the second color paint upon the wall surface without engaging the second color paint upon the wall surface.
